(19) United States
(12) Patent Application Publication
(10) Pub. No.: US 2008/0292313 A1
(43) Pub. Date: Nov. 27, 2008

(54) Methods, Systems, and Computer-Readable Media for Ranging a Device in a Point-to-Multipoint Network

(76) Inventors: Glenn Mark Mahony, Duluth, GA (US); Mounire El Houmaidi, Atlanta, GA (US); Homayoun Torab, Snellville, GA (US)

Correspondence Address: HOPE BALDAUFF HARTMAN, LLC, 1720 PEACHTREE STREET, N.W, SUITE 1010, ATLANTA, GA, 30309, US

(21) Appl. No.: 11/753,758

(22) Filed: May 25, 2007

(51) Int. Cl. H04J 14/00; H04J 14/08

(52) U.S. Cl. 398/52; 398/45; 398/99

(57) ABSTRACT

Methods, systems, and computer-readable media provide for ranging a device in a point-to-multipoint network. According to embodiments, a method for ranging a device in a point-to-multipoint network is provided. According to the method, a device identifier representing a drop in the point-to-multipoint network where the device is installed is received. The device identifier is associated with the device. The device identifier and a unique identifier associated with the device are transmitted over the point-to-multipoint network to a central unit for ranging the device in the point-to-multipoint network.

### TECHNICAL FIELD

This application relates generally to the field of communications networks. More specifically, the disclosure provided herein relates to the field of ranging a device in a point-to-multipoint network.

### BACKGROUND

The rapid growth of the Internet and other networks has led to increasing demand for higher speeds and higher bandwidth to support the efficient and reliable transmission of video, audio, images, text, multimedia, and other data. Fiber optics provides a means by which to transmit such data at high speeds, at a high bandwidth, and with minimal data degradation. While a number of existing networks may utilize fiber optic cables for at least a portion of the network, the connection to the end user or customer has historically been established with more cost-effective copper cables, which typically transfer data at lower speeds, at a lower bandwidth, and with a higher risk of data loss than with fiber optic cables.

The deployment of fiber optics to homes, businesses, and other entities is known as fiber to the X (“FTTX”), in which the X may refer to, for example, the curb, the building, the premise, or the home. FTTX may be deployed using a point-to-multipoint configuration known as a passive optical network (“PON”). With a PON, data from an optical line termination (“OLT”) is transmitted on single fiber and is shared, via an optical splitter, among a plurality of optical network terminations (“ONTs”), optical network units (“ONUs”), multi-dwelling units (“MDUs”), or the like. A PON is termed “passive” because there are no active electronics between the OLT and the ONTs. The OLT broadcasts the same signals, via the optical splitter, to all ONTs in the PON. The ONTs may restrict the signals provided to the end user, however. For example, while the OLT may broadcast a plurality of offered services, such as plain old telephone service (“POTS”), voice over Internet Protocol (“VOIP”), broadband, and Internet Protocol television (“IPTV”), to all the ONTs, the ONTs may restrict their signal output to only those services subscribed by the end user customers.

When deploying FTTX, a technician typically installs the ONT at or near the home, business, or other entity. The ONT may be assigned to a serial number or other unique identifier to identify that particular ONT. In a process known as “ranging,” once the ONT is physically installed, the technician may contact an operations support system (“OSS”) operator and provide the OSS operator with a PON assignment (i.e., the shelf, slot, or port of the PON) and the unique identifier of the ONT. Prior to the technician installing the ONT, the PON assignment is associated with customer information, such as the customer's name, address, or list of subscribed services. The OSS operator will pre-provision an element management system (“EMS”) using the unique identifier provided by the technician. The pre-provisioning process associates the ONT with the PON assignment, thereby associating the ONT with the customer information as well.

When the OLT discovers the installed ONT in the PON, the OLT compares the discovered unique identifier (e.g., the serial number of the installed ONT) with the pre-provisioned unique identifier. If the unique identifier of the ONT is properly pre-provisioned, then the OLT will recognize the discovered unique identifier as a valid ONT to which to provide services. The unique identifiers associated with the ONT are known to be long strings, however (e.g., eight bytes). Thus, if the technician misstates the unique identifier of the ONT or the OSS operator incorrectly records the unique identifier, the ONT will not be properly pre-provisioned, and the customer may not receive service. As such, the existing process by which ONTs are installed and pre-provisioned is subject to human error. Further, the existing process requires that the PON assignment be associated with customer information prior to the technician installing the ONT.

### SUMMARY

Embodiments of the disclosure presented herein include methods, systems, and computer-readable media for ranging a device in a point-to-multipoint network. According to one aspect, a method for ranging a device in a point-to-multipoint network is provided. According to the method, a device identifier representing a drop in the point-to-multipoint network where the device is installed is received. The device identifier is associated with the device. The device identifier and a unique identifier associated with the device are transmitted over the point-to-multipoint network to a central unit for ranging the device in the point-to-multipoint network.

According to another aspect, a system for ranging a device in a point-to-multipoint network is provided. The system includes a memory and a processor functionally coupled to the memory. The memory stores a program containing code for ranging a device in a point-to-multipoint network. The processor is responsive to computer-executable instructions contained in the program and operative to receive a device identifier representing a drop in the point-to-multipoint network where the device is installed, associate the device identifier with the device, and transmit the device identifier and a unique identifier associated with the device over the point-to-multipoint network to a central unit for ranging the device in the point-to-multipoint network.

According to yet another aspect, a computer-readable medium having instructions stored thereon for execution by a processor to perform a method for ranging a device in a point-to-multipoint network is provided. According to the method, a device identifier representing a drop in the point-to-multipoint network where the device is installed is received. The device identifier is associated with the device. The device identifier and a unique identifier associated with the device are transmitted over the point-to-multipoint network to a central unit for ranging the device in the point-to-multipoint network.

Other systems, methods, and/or computer program products according to embodiments will be or become apparent to one with skill in the art upon review of the following drawings and detailed description. It is intended that all such additional systems, methods, and/or computer program products be included within this description, be within the scope of the present invention, and be protected by the accompanying claims.

### BRIEF DESCRIPTION OF THE DRAWINGS

FIG. 1 is a block diagram illustrating an optical network termination (“ONT”), in accordance with exemplary embodiments.

FIG. 2 is a block diagram illustrating a passive optical network (“PON”), in accordance with exemplary embodiments.

FIG. 3 is a block diagram illustrating an exemplary embodiment of the ONT.

FIG. 4 is a flow diagram illustrating a method for ranging the ONT, in accordance with exemplary embodiments.

FIG. 5 is a flow diagram illustrating another method for ranging the ONT, in accordance with exemplary embodiments.

### DETAILED DESCRIPTION

The following detailed description is directed to methods, systems, and computer-readable media for ranging a device in a point-to-multipoint network. In the following detailed description, references are made to the accompanying drawings that form a part hereof, and which are shown by way of illustration specific embodiments or examples.

For the sake of simplicity and without limitation, embodiments described herein will refer primarily to passive optical networks (“PONs”). However, it will be apparent to those of ordinary skill in the art that the described embodiments may be applicable for any suitable wired or wireless point-to-multipoint networks. Further, for the sake of simplicity and without limitation, the PONs described in embodiments herein refer primarily to optical network terminations (“ONTs”). However, it will be apparent to those of ordinary skill in the art that the ONTs may be substituted with optical network units (“ONUs”), multi-dwelling units (“MDUs”), or the like. Additionally, it should be appreciated that the embodiments described herein may be applicable for any suitable FTTX deployment including, but not limited to, fiber to the curb (“FTTC”), fiber to the building (“FTTB”), fiber to the premise (“FTTP”), and fiber to the home (“FTTH”).

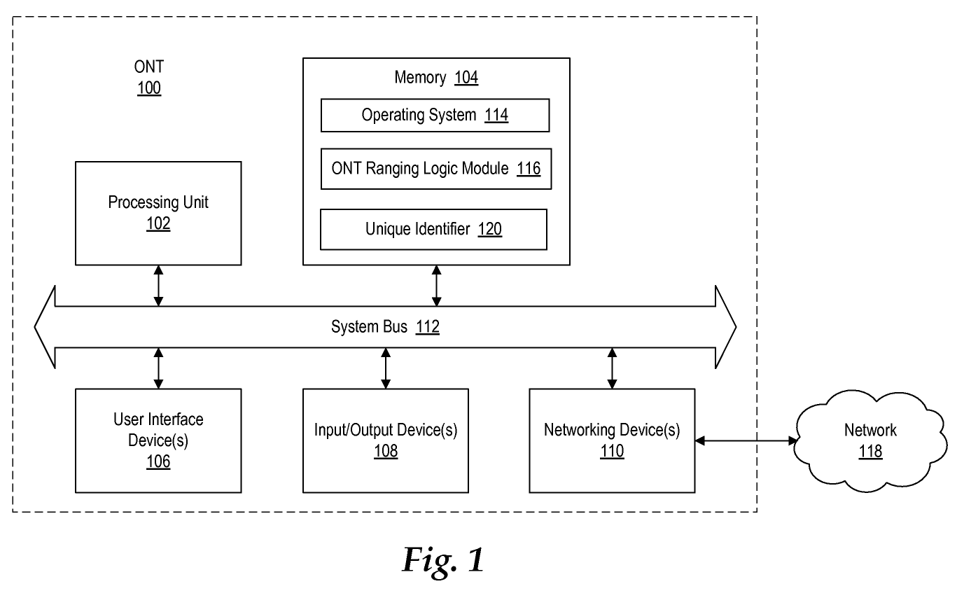

Referring now to the drawings, it is to be understood that like numerals represent like elements through the several figures, and that not all components and/or steps described and illustrated with reference to the figures are required for all embodiments. FIG. 1 and the following discussion are intended to provide a brief, general description of a suitable computing environment in which embodiments may be implemented. While embodiments will be described in the general context of program modules that execute in conjunction with an application program that runs on an operating system on a computer system, those skilled in the art will recognize that the embodiments may also be implemented in combination with other program modules.

Generally, program modules include routines, programs, components, data structures, and other types of structures that perform particular tasks or implement particular abstract data types. Moreover, those skilled in the art will appreciate that embodiments may be practiced with other computer system configurations, including hand-held devices, multiprocessor systems, microprocessor-based or programmable consumer electronics, minicomputers, mainframe computers, and the like. The embodiments may also be practiced in distributed computing environments where tasks are performed by remote processing devices that are linked through a communications network. In a distributed computing environment, program modules may be located in both local and remote memory storage devices.

FIG. 1 is a block diagram illustrating an optical network termination (“ONT”) 100, in accordance with exemplary embodiments. The ONT 100 includes a processing unit 102, a memory 104, one or more user interface devices 106, one or more input/output (“I/O”) devices 108, and one or more network devices 110, each of which is operatively connected to a system bus 112. The bus 112 enables bi-directional communication between the processing unit 102, the memory 104, the user interface devices 106, the I/O devices 108, and the network devices 110. Examples of the ONT 100 include, but are not limited to, computers, servers, personal digital assistants, cellular phones, or any suitable computing devices.

The processing unit 102 may be a standard central processor that performs arithmetic and logical operations, a more specific purpose programmable logic controller (“PLC”), a programmable gate array, or other type of processor known to those skilled in the art and suitable for controlling the operation of the server computer. Processing units are well-known in the art, and therefore not described in further detail herein.

The memory 104 communicates with the processing unit 102 via the system bus 112. In one embodiment, memory 104 is operatively connected to a memory controller (not shown) that enables communication with the processing unit 102 via the system bus 112. The memory 104 includes an operating system 114, an ONT ranging logic module 116, and a unique identifier 120, such as a serial number, according to exemplary embodiments. Examples of operating systems, such as operating system 114, include, but are not limited to, WINDOWS operating system from MICROSOFT CORPORATION, LINUX operating system, and FREEBSD operating system. In one embodiment, the ONT ranging logic module 116 is embodied in computer-readable media containing instructions that, when executed by the processing unit 102, perform a method of ranging an ONT for FTTX deployment, as described in greater detail below. According to further embodiments, the ONT ranging logic module 116 may be embodied in hardware, software, firmware, or any combination thereof. In one embodiment, the unique identifier 120 uniquely identifies a particular ONT from the plurality of ONTs available.

By way of example, and not limitation, computer-readable media may comprise computer storage media and communication media. Computer storage media includes volatile and non-volatile, removable and non-removable media implemented in any method or technology for storage of information such as computer-readable instructions, data structures, program modules, or other data. Computer storage media includes, but is not limited to, RAM, ROM, Erasable Programmable ROM (“EPROM”), Electrically Erasable Programmable ROM (“EEPROM”), flash memory or other solid state memory technology, CD-ROM, digital versatile disks (“DVD”), or other optical storage, magnetic cassettes, magnetic tape, magnetic disk storage or other magnetic storage devices, or any other medium which can be used to store the desired information and which can be accessed by the ONT 100.

The user interface devices 106 may include one or more devices with which a user accesses the ONT 100. The user interface devices 106 may include, but are not limited to, computers, servers, personal digital assistants, cellular phones, home routers, or any suitable computing devices. The I/O devices 108 enable a user to interface with the ONT ranging logic module 116. In one embodiment, the I/O devices 108 are operatively connected to an I/O controller (not shown) that enables communication with the processing unit 102 via the system bus 112. The I/O devices 108 may include one or more input devices, such as, but not limited to, a keyboard, a mouse, or an electronic stylus. Further, the I/O devices 108 may include one or more output devices, such as, but not limited to, a display screen or a printer.

The one or more network devices 110 enable the ONT 100 to communicate with other networks or remote systems via a network 118. Examples of network devices 110 may include, but are not limited to, a modem, a radio frequency (“RF”) or infrared (“IR”) transceiver, a telephonic interface, a bridge, a router, or a network card. The network 118 may include a wireless network such as, but not limited to, a Wireless Local Area Network (“WLAN”) such as a WI-FI network, a Wireless Wide Area Network (“WWAN”), a Wireless Personal Area Network (“WPAN”) such as BLUETOOTH, a Wireless Metropolitan Area Network (“WMAN”) such a WiMAX network, or a cellular network. Alternatively, the network 118 may be a wired network such as, but not limited to, a Passive Optical Network (“PON”), a Wide Area Network (“WAN”) such as the Internet, a Local Area Network (“LAN”) such as the Ethernet, a wired Personal Area Network (“PAN”), or a wired Metropolitan Area Network (“MAN”).

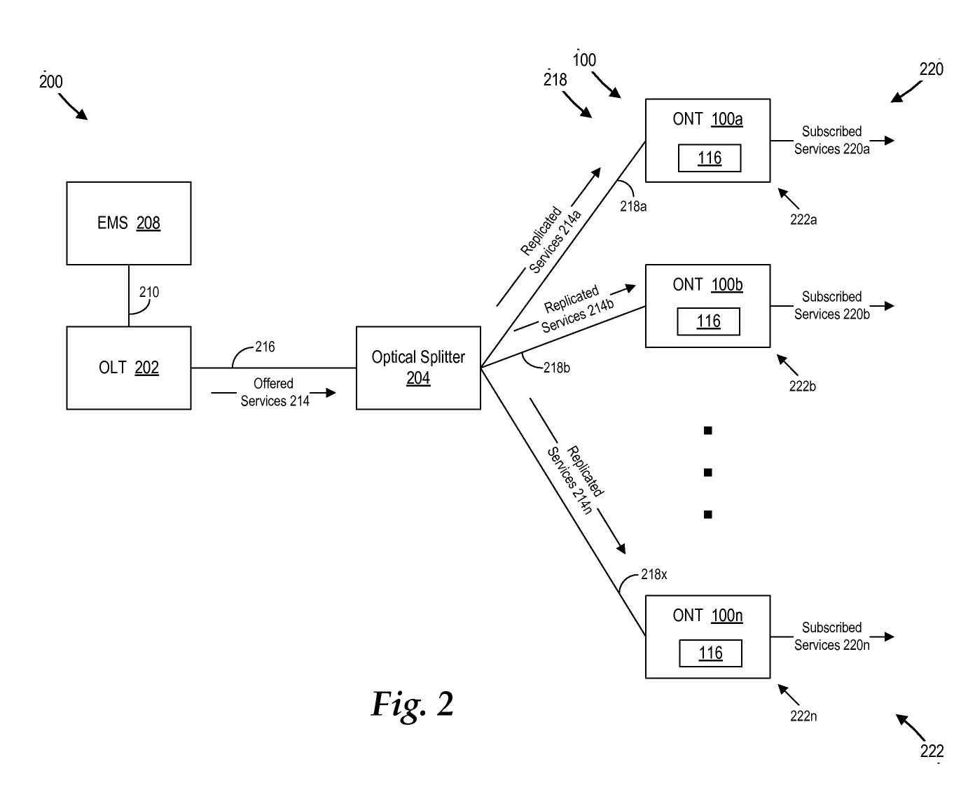

FIG. 2 is a block diagram illustrating a passive optical network (“PON”) 200, in accordance with exemplary embodiments. The PON 200 includes an optical line termination (“OLT”) 202 coupled to a plurality of ONTs 100a-100n (collectively ONTs 100) via an optical splitter 204. The OLT 202 is further coupled to an element management system (“EMS”) 208 via a network 210. The network 210 may include a wireless network such as, but not limited to, a WLAN such as a WI-FI network, a WWAN, a WPAN such as BLUETOOTH, a WMAN such a WiMAX network, or a cellular network. Alternatively, the network 210 may be a wired network such as, but not limited to, a WAN such as the Internet, a LAN such as the Ethernet, a wired PAN, or a wired MAN. The PON 200 includes any suitable number of ONTs, according to exemplary embodiments. For example, a Broadband Passive Optical Network (“BPON”) standard may support up to thirty-two ONTs, and a Gigabit Passive Optical Network (“GPON”) standard may support up to sixty-four ONTs. In further embodiments, the PON 200 may include two or more optical splitters 204.

Data transmissions between the OLT 202 and ONTs 100 may be achieved using any suitable transmission standard including, but not limited to, BPON, GPON, Asynchronous Transfer Mode Passive Optical Network (“APON”), or Ethernet Passive Optical Network (“EPON”). A transmission from the OLT 202 to the ONTs 100 is referred to herein as a “downstream transmission.” A transmission from the ONTs 100 to the OLT 202 is referred to herein as an “upstream transmission.” In one embodiment, the OLT 202 is located at a service provider's central office (“CO”). In further embodiments, the OLT 202 is deployed at the service provider's enclosure, such as a cabinet or a Controlled Environment Vault (“CEV”). Each ONT 100 is located at or near the customer's home, business, or other entity, according to exemplary embodiments.

For downstream transmissions, the service provider at the OLT 202 may broadcast offered services 214 or other data through a fiber 216 to customers at all the ONTs 100. The offered services 214 are embodied in one or more optical signals utilizing one or more optical wavelengths, according to exemplary embodiments. The optical splitter 204 “passively” replicates the offered services 214 from the OLT 202 and transmits the replicated services 214a-214n through fibers 218a-218n (collectively fibers 218) to the ONTs 100. When the ONTs 100 receive the replicated services 214a-214n from the optical splitter 204, the ONTs 100 may restrict the replicated services 214a-214n to only subscribed services 220a-220n (collectively subscribed services 220) according to, for example, the individual customer information associated with each respective ONT 100. The customer information may include, but is not limited to, the customer's name, address, and list of subscribed services. The subscribed services 220 are embodied in a plurality of electrical signals, according to exemplary embodiments. In such embodiments, the ONTs 100 may convert received optical signals to the electrical signals.

For upstream transmissions, the ONTs 100 may transmit data to the OLT 202 at different time slots allocated by the OLT 202 for each ONT 100. The allocated time slots may be managed using any suitable access protocol including, but not limited to, the time division multiple access (“TDMA”) protocol. In one embodiment, the ONTs 100 convert data embodied in one or more electrical signals into one or more optical signals prior to transmission to the OLT 202.

The ONTs 100 each include the ONT ranging logic module 116 of FIG. 1. The embodiments described herein enable the ONT ranging logic module 116 to automatically transmit the serial number or other unique identifier 120 associated with each respective ONT 100 to the OLT 202. The embodiments enable ranging the ONTs 100, which includes providing the serial number for each ONT 100 to an OSS operator, without the need for a technician to contact the OSS operator. Thus, the process of ranging the ONTs 100 can be automatically and reliably performed without the possibility of human error between the technician and the OSS operator.

Prior to installing the ONTs 100, each drop 222a-222n (collectively drops 222) (i.e., location) in the PON 200 where an ONT 100 will be provided is associated with a specific ONT identifier, according to exemplary embodiments. In one embodiment, the number of ONT identifiers is equivalent to at least the number of ONTs 100 in the PON 200. For example, if the PON 200 includes thirty-two ONTs 100, then at least thirty-two ONT identifiers are required since at least thirty-two drops 222 will be needed. In a further example, the ONT identifiers are the numbers 1-32, when the PON 200 includes thirty-two ONTs 100. It should be appreciated by those skilled in the art that the ONT identifier may include any numbers, letters, and/or characters in any suitable arrangement. When a technician installs an ONT 100 at or near a particular drop 222, the technician associates the ONT ranging logic module 116 to the ONT identifier of that particular drop 222, as further described below. Once the ONT 100 is installed, the ONT 100 may initiate a ranging procedure in which the ONT 100 transmits its associated ONT identifier from the ONT ranging logic module 116 as well as the serial number or other unique identifier 120 to the OLT 202.

If the EMS 208 is pre-provisioned such that the unique identifier 120 and customer information are associated, the OLT 202 will recognize the ONT 100 associated with the unique identifier 120 as a valid ONT to which to transmit service. According to exemplary embodiments, the EMS 208 is pre-provisioned regarding a particular ONT, such as ONT 100a, if prior to installation of the ONT 100a at the drop 222a, the ONT identifier associated with the drop 222a is associated with customer information of the customer who will receive service from the ONT 100a and is stored in the EMS 208. When the OLT 202 receives a ranging transmission with an ONT identifier and the unique identifier 120 from the ONT 100a, the OLT 202 may compare the transmitted ONT identifier with the ONT identifiers stored in EMS 208. If the transmitted ONT identifier matches one of the ONT identifiers stored in the EMS 208 and the EMS 208 is pre-provisioned, then the OLT 202 associates the transmitted unique identifier 120 of the ONT 100a with the customer information associated with the matching ONT identifier. Once the serial number and customer information are associated, the OLT 202 recognizes the ONT 100a as a valid ONT to which service can be provided.

Even if the EMS 208 is not pre-provisioned and the unique identifier 120 and the customer information are not associated, the OLT 202 will be able to connect to and recognize the ONT 100 via the ONT identifier. For example, the EMS 208 is not pre-provisioned regarding a particular ONT, such as ONT 100b, if prior to the installation of the ONT 100b, the ONT identifier associated with the drop 222b is not associated with customer information of the customer who will receive service from the ONT 100b. When the OLT 202 receives the ranging transmission from the ONT 100b, the OLT 202 may compare the transmitted ONT identifier with ONT identifiers stored in the EMS 208. If the transmitted ONT identifier matches one of the ONT identifiers stored in the EMS 208 but the EMS 208 is not pre-provisioned, then the OLT 202 associates the transmitted unique identifier 120 of the ONT 100b with the stored ONT identifier such that the ONT 100b can be connected to and recognized. However, since no customer information is associated with the stored ONT identifier, the ONT 100b may be considered an invalid ONT to which service may not be provided.

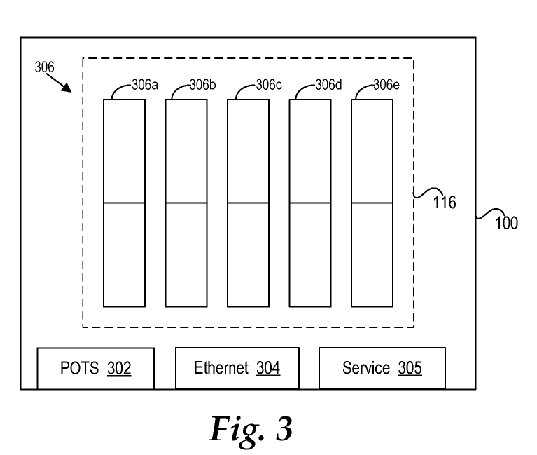

FIG. 3 is a block diagram illustrating an exemplary embodiment of the ONT 100. The ONT 100 includes a plain old telephone service (“POTS”) port 302, an Ethernet port 304, and a service interface port 305, such as Digital Signal 1 (“DS1”), Very High Speed Digital Subscriber Line 2 (“VDSL2”), coaxial, and the like, according to one embodiment. In further embodiments, the ONT 100 may include any suitable ports, such as craft ports, or other physical interfaces. The ONT 100 further includes the ONT ranging logic module 116. The ONT ranging logic module 116 may include a plurality of dual inline package (“DIP”) switches 306a-306e (collectively DIP switches 306). Each DIP switch 306 may represent one bit. For example, a down DIP switch 306 may represent zero, and an up DIP switch 306 may represent one. Alternatively, the down DIP switch 306 may represent one, and the up DIP switch 306 may represent zero. While the ONT ranging logic module 116 illustrated in FIG. 3 includes five DIP switches 306, it should be appreciated that the ONT ranging logic module 116 may include any suitable number of DIP switches 306. In one embodiment, the number of DIP switches 306 in the ONT ranging logic module 116 corresponds to at least the minimum number of bits required to represent the number of ONT identifiers in the PON 200. For example, the ONT ranging logic module 116 may include at least five DIP switches 306 to correspond to the five bits required to represent thirty-two ONT identifiers.

Referring to FIGS. 2 and 3, when the technician installs an ONT, such as the ONT 100a, at or near a drop, such as the drop 222a, the technician sets the DIP switches 306 to the ONT identifier of the drop 222a. As previously described, prior to installing the ONT 100a, the drop 222a is associated with the ONT identifier, according to one embodiment. After the technician installs the ONT 100a and inputs the ONT identifier using the DIP switches 306, the ONT 100a may initiate a ranging procedure in which the ONT 100a transmits its associated ONT identifier set by DIP switches 306 as well as the serial number or other unique identifier 120 associated with the ONT 100a to the OLT 202. If the EMS 208 is pre-provisioned such that the unique identifier 120 and customer information are associated, the OLT 202 will recognize the ONT 100a associated with the unique identifier 120 as a valid ONT to which to transmit service. Even if the EMS 208 is not pre-provisioned and the unique identifier 120 and the customer information are not associated, the OLT 202 will be able to connect to and recognize the ONT 100a via the ONT identifier.

In further embodiments, the ONT ranging logic module 116 provides a user interface (not shown), such as a graphical user interface (“GUI”), with which the technician inputs the ONT identifier. In one embodiment, the technician physically connects a computer into the ONT 100a via the POTS port 302, the Ethernet port 304, the service interface port 305, or other physical interface such that the technician can access the user interface through the computer. Thus, for example, when the technician installs the ONT 100a at or near a drop, such as the drop 222a, the technician may connect a computer into the ONT 100a, access the user interface, and input the ONT identifier of the drop 222a. After the technician installs the ONT 100 and inputs the ONT identifier via the interface, the ONT 100 may initiate a ranging procedure in which the ONT 100 transmits its associated ONT identifier set by the user interface as well as the serial number or other unique identifier 120 to the OLT 202. If the EMS 208 is pre-provisioned such that the unique identifier 120 and customer information are associated, the OLT 202 will recognize the ONT 100 associated with the unique identifier 120 as a valid ONT to which to transmit service. Even if the EMS 208 is not pre-provisioned and the unique identifier 120 and the customer information are not associated, the OLT 202 will be able to connect to and recognize the ONT 100 via the ONT identifier.

In one embodiment, the ONT ranging logic module 116 may be secured to prevent access from someone other than the technician. For example, if the ONT ranging logic module 116 includes the DIP switches 306, the DIP switches 306 may be contained in a locked or otherwise secured portion of the ONT 100. If the ONT ranging logic module 116 provides a user interface with which the technician inputs the ONT identifier, access to the user interface may be restricted or otherwise secured before and/or after the technician inputs the ONT identifier. In one embodiment, access to the user interface requires at least a password. In further embodiments, access to the user interface is restricted once the technician first inputs the ONT identifier.

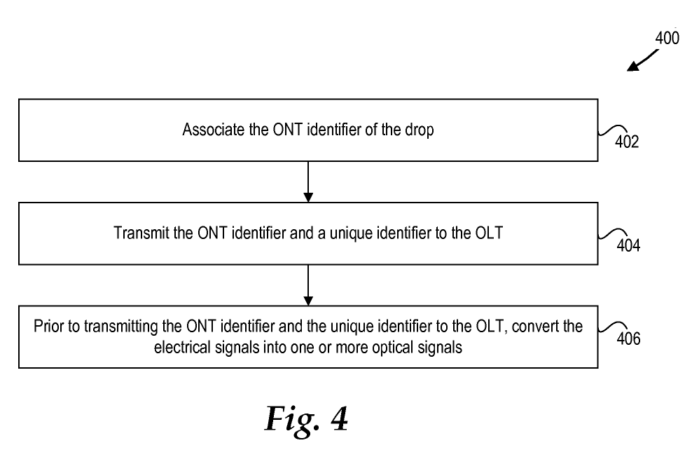

FIG. 4 is a flow diagram illustrating a method 400 for ranging the ONT 100, in accordance with exemplary embodiments. Referring to FIGS. 2, 3, and 4, once the technician installs an ONT 100a at a drop, the technician associates (at 402) the ONT identifier of the drop with the ONT 100a via the ONT ranging logic module 116. As described above, the ONT ranging logic module 116 may include the DIP switches 306 and/or may provide an interface for associating the ONT 100a with the ONT identifier of the drop 222a. Further, the ONT ranging logic module 116 may include any hardware or software component operative to associate the ONT 100a with an identifier such as the ONT identifier. In one embodiment, the ONT 100a includes a plurality of DIP switches 306, and the technician adjusts the DIP switches 306 up or down to correspond to the ONT identifier of the drop 222a to associate the ONT 100a. In further embodiments, in which the DIP switches 306 are replaced with a user interface, the technician may physically connect a computer with the ONT 100a via the POTS port 302, the Ethernet port 304, the service interface port 305, or other physical interface such that the technician can access the user interface through the computer. The user interface may be configured to enable the technician to input the ONT identifier.

After the technician installs the ONT 100a and associates the ONT identifier, the ONT 100a may initiate a ranging procedure in which the ONT 100a transmits (at 404) its associated ONT identifier set by the ONT ranging logic module 116 as well as the serial number or other unique identifier 120 to the OLT 202. According to exemplary embodiments, each ONT 100 includes a serial number or other identifier which uniquely identifies the ONT 100. Further, the EMS 208 is pre-provisioned regarding a particular ONT, such as ONT 100a, if prior to installation of the ONT 100a at the drop 222a, the ONT identifier associated with the drop 222a is associated with customer information of the customer who will receive service from the ONT 100a and is stored in the EMS 208. When the OLT 202 receives a ranging transmission with an ONT identifier and the unique identifier 120 from the ONT 100a, the OLT 202 may compare the transmitted ONT identifier with the ONT identifiers stored in EMS 208. If the transmitted ONT identifier matches one of the ONT identifiers stored in the EMS 208 and the EMS 208 is pre-provisioned, then the OLT 202 associates the transmitted unique identifier 120 of the ONT 100a with the customer information associated with the matching ONT identifier. Once the serial number and customer information are associated, the OLT 202 recognizes the ONT 100a as a valid ONT to which service can be provided.

Even if the EMS 208 is not pre-provisioned and the unique identifier 120 and the customer information are not associated, the OLT 202 will be able to connect to and recognize the ONT 100a via the ONT identifier. For example, the EMS 208 is not pre-provisioned regarding a particular ONT, such as ONT 100b, if prior to the installation of the ONT 100b, the ONT identifier associated with the drop 222b is not associated with customer information of the customer who will receive service from the ONT 100b. When the OLT 202 receives the ranging transmission from the ONT 100b, the OLT 202 may compare the transmitted ONT identifier with ONT identifiers stored in the EMS 208. If the transmitted ONT identifier matches one of the ONT identifiers stored in the EMS 208 but the EMS 208 is not pre-provisioned, then the OLT 202 associates the transmitted unique identifier 120 of the ONT 100b with the stored ONT identifier such that the ONT 100b can be connected to and recognized. However, since no customer information is associated with the stored ONT identifier, the ONT 100b may be considered an invalid ONT to which service may not be provided.

According to exemplary embodiments, the EMS 208 is pre-provisioned regarding a particular ONT, such as ONT 100a, if prior to installation of the ONT 100a at the drop 222a, the ONT identifier associated with the drop 222a is associated with customer information of the customer who will receive service from the ONT 100a and is stored in the EMS 208. When the OLT 202 receives a ranging transmission with an ONT identifier and the unique identifier 120 from the ONT 100a, the OLT 202 may compare the transmitted ONT identifier with the ONT identifiers stored in EMS 208. If the transmitted ONT identifier matches one of the ONT identifiers stored in the EMS 208 and the EMS 208 is pre-provisioned, then the OLT 202 associates the transmitted unique identifier 120 of the ONT 100a with the customer information associated with the matching ONT identifier. Once the serial number and customer information are associated, the OLT 202 recognizes the ONT 100a as a valid ONT to which service can be provided.

In one embodiment, the ONT identifier received from the DIP switches 306 or the user interface is embodied in one or more electrical signals. Thus, prior to transmitting the ONT identifier and the unique identifier 120 to the OLT 202, the ONT 100a may convert (at 406) the electrical signals that embody the ONT identifier into one or more optical signals.

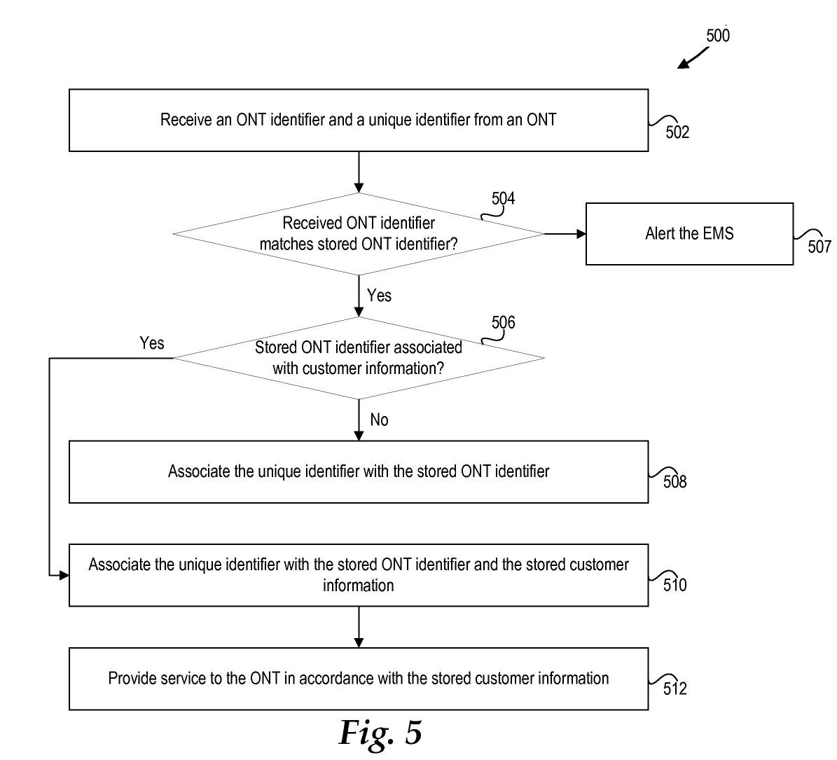

FIG. 5 is a flow diagram illustrating another method 500 for ranging the ONT 100, in accordance with exemplary embodiments. Referring to FIGS. 2, 3, and 5, when an ONT, such as ONT 100a, initiates the ranging procedure with the OLT 202, the OLT 202 receives (at 502) an ONT identifier and the serial number or other unique identifier 120 from the ONT ranging logic module 116 of the ONT 100a. The OLT 202 compares (at 504) the received ONT identifier with information stored in the EMS 208. If the received ONT identifier matches an ONT identifier stored in the EMS 208, then the OLT 202 determines (at 506) whether the stored ONT identifier is associated with customer information stored in the EMS 208. If the received ONT identifier does not match an ONT identifier stored the EMS 208, the OLT 202 alerts (at 507) the EMS 208, and the ONT 100a may appear as non-provisioned, requiring user intervention. If the received ONT identifier is not associated with customer information, then the unique identifier 120 of the ONT 100a is associated (at 508) with the stored ONT identifier. If the received ONT identifier is associated with customer information, then the unique identifier 120 of the ONT 100a is associated (at 510) with the stored ONT identifier and the stored customer information. Further, the OLT 202 provides (at 512) service to the ONT 100a in accordance with the stored customer information. As described above, the customer information may include, for example, a list of subscribed services.

Embodiments described and illustrated with reference to the Figures provide methods, systems, and computer-readable media for ranging a device in a point-to-multipoint network. Embodiments described enable a technician to install and range a device, such as an ONT, ONU, or MDU, in a point-to-multipoint network, such as a PON, without the need to call an OSS operator to provide the unique identifier and PON assignment. Further, embodiments described enable a technician to install and range a device with having customer information already associated with the drop where the device is installed.

Although the subject matter presented herein has been described in conjunction with one or more particular embodiments and implementations, it is to be understood that the embodiments defined in the appended claims are not necessarily limited to the specific structure, configuration, or functionality described herein. Rather, the specific structure, configuration, and functionality are disclosed as example forms of implementing the claims.

The subject matter described above is provided by way of illustration only and should not be construed as limiting. Various modifications and changes may be made to the subject matter described herein without following the example embodiments and applications illustrated and described, and without departing from the true spirit and scope of the embodiments, which is set forth in the following claims.

What is claimed is:

1. A method for ranging a device in a point-to-multipoint network, comprising:
receiving a device identifier representing a drop in the point-to-multipoint network where the device is installed;
associating the device identifier with the device; and
transmitting the device identifier and a unique identifier associated with the device over the point-to-multipoint network to a central unit for ranging the device in the point-to-multipoint network.

2. The method of claim 1, wherein the device comprises an optical network termination (ONT), wherein the point-to-multipoint network comprises a passive optical network (PON), and wherein the device identifier comprises an ONT identifier representing the drop in the PON where the ONT is installed.

3. The method of claim 1, wherein the device identifier is received from a plurality of dual inline package (DIP) switches associated with the device.

4. The method of claim 1, wherein the device identifier is received from a user interface associated with the device.

5. The method of claim 1, wherein a total number of device identifiers is at least equal to a total number of devices in the point-to-multipoint network.

6. The method of claim 1, wherein the device identifier and the unique identifier are transmitted over the point-to-multipoint network in an allocated time slot managed under a time division multiple access (TDMA) protocol.

7. The method of claim 1, further comprising:
converting the device identifier to an optical signal prior to transmitting the device identifier and the unique identifier over the point-to-multipoint network.

8. A system for ranging a device in a point-to-multipoint network, comprising:
a memory for storing a program containing code for ranging the device in the point-to-multipoint network, comprising;
a processor functionally coupled to the memory, the processor being responsive to computer-executable instructions contained in the program and operative to:
receive a device identifier representing a drop in the point-to-multipoint network where the device is installed;
associate the device identifier with the device; and
transmit the device identifier and a unique identifier associated with the device over the point-to-multipoint network to a central unit for ranging the device in the point-to-multipoint network.

9. The system of claim 8, wherein the device comprises an optical network termination (ONT), wherein the point-to-multipoint network comprises a passive optical network (PON), and wherein the device identifier comprises an ONT identifier representing the drop in the PON where the ONT is installed.

10. The system of claim 8, further comprising:
a plurality of dual inline package (DIP) switches associated with the device operative to provide the device identifier.

11. The system of claim 8, further comprising:
a user interface associated with the device that is configured for a user to enter the device identifier.

12. The system of claim 8, wherein a total number of device identifiers is at least equal to a total number of devices in the point-to-multipoint network.

13. The system of claim 8, wherein the device identifier and the unique identifier are transmitted over the point-to-multipoint network in an allocated time slot managed under a time division multiple access (TDMA) protocol.

14. A computer-readable medium having instructions stored thereon for execution by a processor to perform a method for ranging a device in a point-to-multipoint network, the method comprising:
receiving a device identifier representing a drop in the point-to-multipoint network where the device is installed;
associating the device identifier with the device; and
transmitting the device identifier and a unique identifier associated with the device over the point-to-multipoint network to a central unit for ranging the device in the point-to-multipoint network.

15. The computer-readable medium of claim 14, wherein the device comprises an optical network termination (ONT), wherein the point-to-multipoint network comprises a passive optical network (PON), and wherein the device identifier comprises an ONT identifier representing the drop in the PON where the ONT is installed.

16. The computer-readable medium of claim 14, wherein the device identifier is received from a plurality of dual inline package (DIP) switches associated with the device.

17. The computer-readable medium of claim 14, wherein the device identifier is received from a user interface associated with the device.

18. The computer-readable medium of claim 14, wherein a total number of device identifiers is at least equal to a total number of devices in the point-to-multipoint network.

19. The computer-readable medium of claim 14, wherein the device identifier and the unique identifier are transmitted over the point-to-multipoint network in an allocated time slot managed under a time division multiple access (TDMA) protocol.

20. The computer-readable medium of claim 14, wherein the method further comprises:
converting the device identifier to an optical signal prior to transmitting the device identifier and the unique identifier over the point-to-multipoint network.
